(19) United States
(12) Patent Application Publication
(10) Pub. No.: US 2007/0280380 A1
(43) Pub. Date: Dec. 6, 2007

(54) METHOD AND DEVICE FOR COMPENSATING INPHASE-QUADRATURE (IQ) IMBALANCE

(76) Inventors: Chun-Ming Cho, Chi-Lung City (TW); Liang-Hui Li, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/754,375

(22) Filed: May 29, 2007

(30) Foreign Application Priority Data
Jun. 5, 2006 (TW) 095119865

(51) Int. Cl. H04L 27/22

(52) U.S. Cl. 375/332

(57) ABSTRACT

A method for compensating Inphase-Quadrature (IQ) imbalance in a receiver includes: generating a gain compensation parameter, a first phase compensation parameter, and a second phase compensation parameter according to a first signal on the I path and a second signal on the Q path of the receiver; and performing compensation on the I path and the Q path according to the gain compensation parameter, the first and the second phase compensation parameters.

### BACKGROUND OF THE INVENTION

1. Field of the Invention

The present invention relates to a communication system, and more particularly, to methods and devices for compensating Inphase-Quadrature (IQ) imbalance.

2. Description of the Prior Art

In the field of wireless communication, super heterodyne receivers are widely applied due to their many advantages, such as great selection capability and high sensitivity. In contrast to super heterodyne receivers, the architecture of direct conversion receivers has the potential to provide a better performance with lower costs. However, the direct conversion receivers have not brought their superiority thereof into full play due to hardware limits and Inphase-Quadrature (IQ) imbalance, which is a common problem that should be resolved. As a result, estimating IQ imbalance has become an important issue in this field.

### SUMMARY OF THE INVENTION

It is therefore an objective of the claimed invention to provide methods and devices for compensating Inphase-Quadrature (IQ) imbalance without introducing a heavy calculation load, to solve the above-mentioned problem.

It is also an objective of the claimed invention to provide methods and devices for compensating IQ imbalance in a receiver.

It is another objective of the claimed invention to provide methods and devices for compensating IQ imbalance in a receiver, whereby the receiver may estimate compensation parameters according to the correlation between an I path and a Q path, and then perform compensation accordingly.

It is another objective of the claimed invention to provide methods and devices for compensating IQ imbalance in a receiver, whereby the receiver may estimate compensation parameters without utilizing a known signal (e.g. the pilot or the test tone).

It is another objective of the claimed invention to provide methods and devices for compensating IQ imbalance in a receiver, whereby the receiver is applicable to a system without any known signal.

It is yet another objective of the claimed invention to provide methods and devices for compensating IQ imbalance in a receiver, whereby compensation parameters estimated by the receiver are independent of a carrier frequency offset.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an I′-Q′ coordinate utilized for compensating Inphase-Quadrature (IQ) imbalance in a receiver according to an embodiment of the present invention.

FIG. 2 is a diagram of a compensation module according to an embodiment of the present invention.

FIG. 3 is a diagram of a compensation parameter generation module according to an embodiment of the present invention.

FIG. 4 is a diagram of a compensation parameter generation module according to another embodiment of the present invention.

FIG. 5 is a diagram of a compensation module according to another embodiment of the present invention.

FIG. 6 is a diagram of a compensation module according to another embodiment of the present invention.

### DETAILED DESCRIPTION

In an ideal case, results derived from I/Q demodulation performed by a receiver are further processed (e.g. filtered or amplified) through the receiver's I path and Q path respectively, to output a signal I and a signal Q, where the signal I and the signal Q are orthogonal. In a real case, in contrast to the ideal case, the signal I and the signal Q mentioned above are respectively re-defined as a signal I′ and a signal Q′, where the signal I′ and the signal Q′ are not orthogonal.

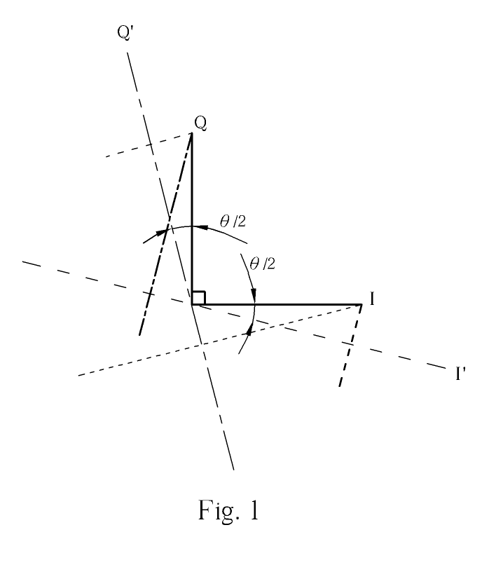

FIG. 1 illustrates an I′-Q′ coordinate utilized for compensating Inphase-Quadrature (IQ) imbalance in a receiver according to an embodiment of the present invention. According to the projection relationship between the I′-Q′ coordinate and the I-Q coordinate shown in FIG. 1, signals I, Q, I′, and Q′ can be respectively written as functions of time t, i.e. I(t), Q(t), I′ (t), and Q′ (t), and have relationships as shown in the following set of equations:

$${I}^{′} ( t ) = ( 1 + \frac{ɛ}{2} ) ( cos \frac{θ}{2} ) I ( t ) - ( 1 + \frac{ɛ}{2} ) ( sin \frac{θ}{2} ) Q ( t ) ;$$

$$and$$

$${Q}^{′} ( t ) = - ( 1 - \frac{ɛ}{2} ) ( sin \frac{θ}{2} ) I ( t ) + ( 1 - \frac{ɛ}{2} ) ( cos \frac{θ}{2} ) Q ( t ) ;$$

where ε is utilized for representing a gain error, and θ is utilized for representing a phase error. The above equations are well known in the art. Please refer to “RF Microelectronics” written by BEHZAD RAZAVI (published by Prentice Hall PRT, Page 135) for detailed descriptions.

First, it is assumed that the variation var(I(t)) of I(t) and the variation var(Q(t)) of Q(t) are equivalent to each other. Then, the variation var(I′(t)) of I′(t) and the variation var(Q′(t)) of Q′(t) can be derived according to the equations mentioned above, as listed in the following:

$$\begin{matrix}\begin{matrix}var ( {I}^{′} ( t ) ) = {( 1 + \frac{ɛ}{2} )}^{2} ( {cos}^{2} \frac{θ}{2} ) var ( I ( t ) ) - {( 1 + \frac{ɛ}{2} )}^{2} ( {sin}^{2} \frac{θ}{2} ) var ( Q ( t ) ) \\ = {( 1 + \frac{ɛ}{2} )}^{2} ( {cos}^{2} \frac{θ}{2} - {sin}^{2} \frac{θ}{2} ) var ( I ( t ) ) ;\end{matrix} \\ and & ( 1 ) \\ \begin{matrix}var ( {Q}^{′} ( t ) ) = {( 1 - \frac{ɛ}{2} )}^{2} ( {cos}^{2} \frac{θ}{2} ) var ( Q ( t ) ) - {( 1 - \frac{ɛ}{2} )}^{2} ( {sin}^{2} \frac{θ}{2} ) var ( I ( t ) ) \\ = {( 1 - \frac{ɛ}{2} )}^{2} ( {cos}^{2} \frac{θ}{2} {sin}^{2} \frac{θ}{2} ) var ( I ( t ) ) .\end{matrix} & ( 2 )\end{matrix}$$

In addition, two gain compensation parameters K_{Q} and K_{I} can be further defined as follows:

$$\begin{matrix}{K}_{Q} = \sqrt{\frac{var ( {I}^{′} ( t ) )}{var ( {Q}^{′} ( t ) )}} = \frac{1 + \frac{ɛ}{2}}{1 - \frac{ɛ}{2}} ; \\ and & ( 3 ) \\ {K}_{I} = \sqrt{\frac{var ( {Q}^{′} ( t ) )}{var ( {I}^{′} ( t ) )}} = \frac{1 - \frac{ɛ}{2}}{1 + \frac{ɛ}{2}} = \frac{1}{{K}_{Q}} . & ( 4 )\end{matrix}$$

Thus, different embodiments of the present invention methods and devices are capable of respectively estimating the power of the signal I′ and the power of the signal Q′ (i.e. estimating a square value of the signal I′ and a square value of the signal Q′) and adjusting at least one of the gain of the signal I′ and the gain of the signal Q′ in real time according to the estimation mentioned above, to balance the power outputted through the I path and the power outputted through the Q path, in order to correct the gain error. According to this embodiment, after the gain adjustment mentioned above, the corresponding signals I″ and Q″ are respectively generated on the I path and the Q path, where the signal I″ and Q″ can be written as respective functions of time t, i.e. I″(t) and Q″(t). Please note that I′(t), Q′(t), I″(t), and Q″(t) have relationship(s) as shown in the following equations:

$$\begin{matrix}[ \begin{matrix}{I}^{″} ( t ) \\ {Q}^{″} ( t )\end{matrix} ] = [ \begin{matrix}1 & 0 \\ 0 & {K}_{Q}\end{matrix} ] [ \begin{matrix}{I}^{′} ( t ) \\ {Q}^{′} ( t )\end{matrix} ] ; \\ or & ( 5 ) \\ [ \begin{matrix}{I}^{″} ( t ) \\ {Q}^{″} ( t )\end{matrix} ] = [ \begin{matrix}{K}_{I} & 0 \\ 0 & 1\end{matrix} ] [ \begin{matrix}{I}^{′} ( t ) \\ {Q}^{′} ( t )\end{matrix} ] . & ( 6 )\end{matrix}$$

That is, in this embodiment, the gain error can be corrected by adjusting at least one of the gain of the signal I′ and the gain of the signal Q′, where the two gain compensation parameters K_{Q} and K_{I} are respectively utilized for adjusting the signals Q′ and I′.

Additionally, regarding correction of the phase error, an average value mean(I′(t) Q′(t)) of a product (I′(t) Q′(t)) of I′(t) and Q′(t) can be calculated first, as shown in the following:

$$\begin{matrix}mean ( {I}^{′} ( t ) {Q}^{′} ( t ) ) = ( 1 - {( \frac{ɛ}{2} )}^{2} ) \cdot mean ( I ( t ) Q ( t ) - ( {I}^{2} ( t ) + {Q}^{2} ( t ) ) sin θ ) \\ = - ( 1 - {( \frac{ɛ}{2} )}^{2} ) \cdot mean ( {I}^{2} ( t ) + {Q}^{2} ( t ) ) sin θ\end{matrix} \\ sin θ = \frac{mean ( {I}^{′} ( t ) {Q}^{′} ( t ) )}{- ( 1 - {( \frac{ɛ}{2} )}^{2} ) \cdot mean ( {I}^{2} ( t ) + {Q}^{2} ( t ) )} . \qquad ( 7 )$$

Given:

$$sin θ = 2 cos ( \frac{θ}{2} ) sin ( \frac{θ}{2} ) ; \qquad ( 8 )$$

as the value of the cosine function cos(θ/2) approaches 1 when θ is very small, the above equation can be re-written as follows:

$$sin θ \approx 2 sin ( \frac{θ}{2} ) \\ sin ( \frac{θ}{2} ) \approx \frac{1}{2} sin θ . \qquad ( 9 )$$

By substituting Equation (7) into Equation (9), the following equation can be derived:

$$sin ( \frac{θ}{2} ) \approx \frac{1}{2} sin θ = \frac{1}{2} \cdot \frac{- 1}{1 - {( \frac{ɛ}{2} )}^{2}} \cdot \frac{mean ( {I}^{′} ( t ) {Q}^{′} ( t ) )}{mean ( {I}^{2} ( t ) + {Q}^{2} ( t ) )} ;$$

as (ε/2)² is much smaller than one, the above equation can be written as follows:

$$\begin{matrix}sin ( \frac{θ}{2} ) \approx - \frac{1}{2} \cdot \frac{mean ( {I}^{′} ( t ) {Q}^{′} ( t ) )}{mean ( {I}^{2} ( t ) + {Q}^{2} ( t ) )} ; & ( 10 ) \\ cos ( \frac{θ}{2} ) = \sqrt{1 - {sin}^{2} ( \frac{θ}{2} )} \approx \sqrt{1 - \frac{1}{4} {( \frac{mean ( {I}^{′} ( t ) {Q}^{′} ( t ) )}{mean ( {I}^{2} ( t ) + {Q}^{2} ( t ) )} )}^{2}} . & ( 11 )\end{matrix}$$

By utilizing the above equations, sin(θ/2) and cos(θ/2) can be estimated, and therefore correction of the phase error by utilizing matrix operations can be further implemented.

Here, the corresponding signals respectively generated on the I path and the Q path after the phase adjustment are defined as a signal I′″ and a signal Q′″. According to the descriptions mentioned above, I(t), Q(t), I′(t), Q′(t), I″(t), Q″(t), I′″(t), and Q′″(t) have relationships as shown in the following equations:

$$\begin{matrix}[ \begin{matrix}{I}^{′′′} \\ {Q}^{′′′}\end{matrix} ] = [ \begin{matrix}cos \frac{θ}{2} & sin \frac{θ}{2} \\ sin \frac{θ}{2} & cos \frac{θ}{2}\end{matrix} ] [ \begin{matrix}{I}^{″} \\ {Q}^{″}\end{matrix} ] \\ = [ \begin{matrix}cos \frac{θ}{2} & sin \frac{θ}{2} \\ sin \frac{θ}{2} & cos \frac{θ}{2}\end{matrix} ] [ \begin{matrix}1 & 0 \\ 0 & {K}_{Q}\end{matrix} ] [ \begin{matrix}{I}^{′} \\ {Q}^{′}\end{matrix} ] \\ = [ \begin{matrix}cos \frac{θ}{2} & sin \frac{θ}{2} \\ sin \frac{θ}{2} & cos \frac{θ}{2}\end{matrix} ] [ \begin{matrix}1 & 0 \\ 0 & {K}_{Q}\end{matrix} ] [ \begin{matrix}1 + \frac{ɛ}{2} & 0 \\ 0 & 1 - \frac{ɛ}{2}\end{matrix} ] \\ [ \begin{matrix}cos \frac{θ}{2} & - sin \frac{θ}{2} \\ - sin \frac{θ}{2} & cos \frac{θ}{2}\end{matrix} ] [ \begin{matrix}I \\ Q\end{matrix} ] ;\end{matrix} \qquad ( 12 )$$

Two of the matrixes to the right of the last equal sign in the above equation can be simplified according to Equation (3) as follows:

$$[ \begin{matrix}1 & 0 \\ 0 & {K}_{Q}\end{matrix} ] [ \begin{matrix}1 + \frac{ɛ}{2} & 0 \\ 0 & 1 - \frac{ɛ}{2}\end{matrix} ] = [ \begin{matrix}1 + \frac{ɛ}{2} & 0 \\ 0 & 1 + \frac{ɛ}{2}\end{matrix} ] = ( 1 + \frac{ɛ}{2} ) [ \begin{matrix}1 & 0 \\ 0 & 1\end{matrix} ] ;$$

Equation (12) can be re-written as follows:

$$\begin{matrix}[ \begin{matrix}{I}^{′′′} \\ {Q}^{′′′}\end{matrix} ] = ( 1 + \frac{ɛ}{2} ) [ \begin{matrix}cos \frac{θ}{2} & sin \frac{θ}{2} \\ sin \frac{θ}{2} & cos \frac{θ}{2}\end{matrix} ] [ \begin{matrix}1 & 0 \\ 0 & 1\end{matrix} ] [ \begin{matrix}cos \frac{θ}{2} & - sin \frac{θ}{2} \\ - sin \frac{θ}{2} & cos \frac{θ}{2}\end{matrix} ] [ \begin{matrix}I \\ Q\end{matrix} ] \\ = ( 1 + \frac{ɛ}{2} ) [ \begin{matrix}cos \frac{θ}{2} & sin \frac{θ}{2} \\ sin \frac{θ}{2} & cos \frac{θ}{2}\end{matrix} ] [ \begin{matrix}cos \frac{θ}{2} & - sin \frac{θ}{2} \\ - sin \frac{θ}{2} & cos \frac{θ}{2}\end{matrix} ] [ \begin{matrix}I \\ Q\end{matrix} ] \\ = ( 1 + \frac{ɛ}{2} ) [ \begin{matrix}{cos}^{2} ( \frac{θ}{2} ) - {sin}^{2} ( \frac{θ}{2} ) & 0 \\ 0 & {cos}^{2} ( \frac{θ}{2} ) - {sin}^{2} ( \frac{θ}{2} )\end{matrix} ] [ \begin{matrix}I \\ Q\end{matrix} ] \\ = ( 1 + \frac{ɛ}{2} ) ( {cos}^{2} ( \frac{θ}{2} ) - {sin}^{2} ( \frac{θ}{2} ) ) [ \begin{matrix}1 & 0 \\ 0 & 1\end{matrix} ] [ \begin{matrix}I \\ Q\end{matrix} ] \\ = ( 1 + \frac{ɛ}{2} ) ( {cos}^{2} ( \frac{θ}{2} ) - {sin}^{2} ( \frac{θ}{2} ) ) [ \begin{matrix}I \\ Q\end{matrix} ] \\ = C [ \begin{matrix}I \\ Q\end{matrix} ] ,\end{matrix}$$

$$where$$

$$C = ( 1 + \frac{ɛ}{2} ) ( {cos}^{2} ( \frac{θ}{2} ) - {sin}^{2} ( \frac{θ}{2} ) ) .$$

Regarding specific values of the gain error ε and the phase error θ, C is constant. Therefore, the signal I′″ and the signal Q′″ derived according to embodiments of the present invention methods are, respectively, the recovered versions of the signal I and the signal Q in an ideal case.

According to different embodiments of the present invention, the gain error can be corrected by adjusting the power of the signal Q′ (e.g. adjusting the power of the signal Q′ by utilizing the gain compensation parameter K_{Q}) or adjusting the power of the signal I′ (e.g. adjusting the power of the signal I′ by utilizing the gain compensation parameter K_{I}). In addition, by estimating sin(θ/2) and cos(θ/2), the phase error can be corrected through matrix operations. Thus, the signal I and the signal Q in the ideal case can be recovered.

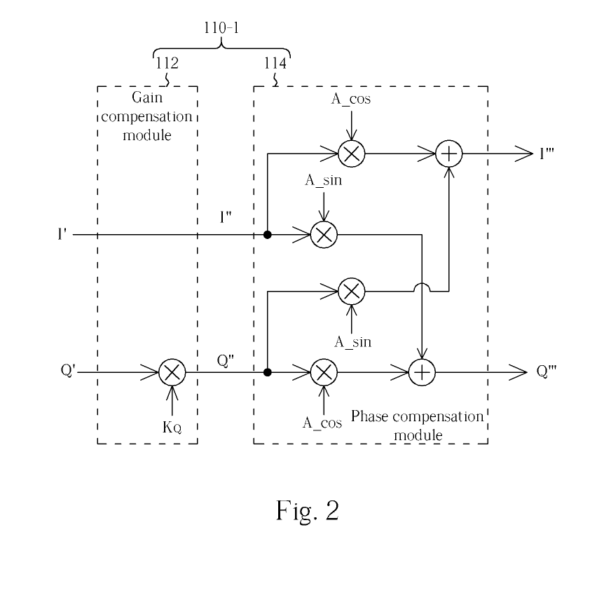

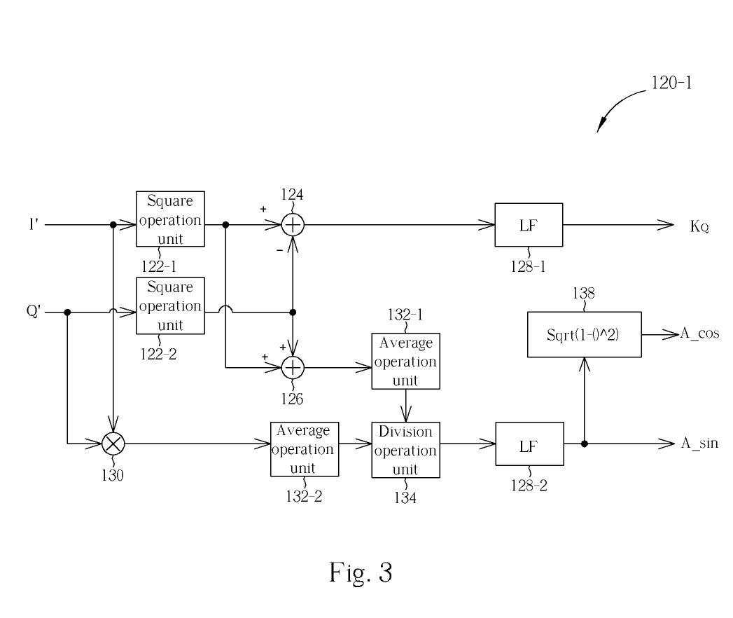

FIG. 2 is a diagram of a compensation module 110-1 according to an embodiment of the present invention. FIG. 3 is a diagram of a compensation parameter generation module 120-1 according to an embodiment of the present invention. As shown in FIG. 2, the compensation module 110-1 comprises a gain compensation module 112 and a phase compensation module 114. The gain compensation module 112 comprises a multiplier utilized for performing gain compensation on the Q path according to the gain compensation parameter K_{Q} generated by the compensation parameter generation module 120-1. The phase compensation module 114 comprises a plurality of multipliers and a plurality of arithmetic units, where these multipliers and arithmetic units are utilized for performing phase compensation on the I path and the Q path according to the phase compensation parameters A_sin and A_cos generated by the compensation parameter generation module 120-1. According to this embodiment, two arithmetic units utilized within the phase compensation module 114 are adders.

As shown in FIG. 3, the compensation parameter generation module 120-1 comprises two square operation units 122-1 and 122-2, two arithmetic units 124 and 126, two filters 128-1 and 128-2 (which are loops filters (LFs) in this embodiment), a multiplier 130, two average operation units 132-1 and 132-2, a division operation unit 134, and a calculation unit 138, where the arithmetic units 124 and 126 are substantially a subtracter and an adder, respectively, and the arithmetic unit 124 can be implemented by utilizing a combination of an adder and an inverter. According to this embodiment, the filters 128-1 and 128-2 can be implemented by utilizing simple low pass filters or average operation units.

The square operation units 122-1 and 122-2 respectively calculate a square value of the signal I′ and a square value of the signal Q′. The arithmetic unit 124 calculates a difference between the square value of the signal I′ and the square value of the signal Q′, and the filter 128-1 performs filtering on the difference to generate the gain compensation parameter K_{Q}. In addition, the arithmetic unit 126 adds the square value of the signal I′ and the square value of the signal Q′ to generate a sum, and the average operation unit 132-1 performs an average operation on the sum to generate a first average value. On the other hand, the multiplier 130 calculates a product of the signal I′ and the signal Q′, and the average operation unit 132-2 performs an average operation on the product to generate a second average value. As a result, the division operation unit 134 divides the first average value by the second average value to generate a quotient, and the filter 128-2 performs filtering (more particularly, loop filtering) on the quotient to generate the phase compensation parameter A_sin. Additionally, the calculation unit 138 receives the phase compensation parameter A_sin to generate the phase compensation parameter A_cos. According to the architecture shown in FIG. 3, the phase compensation parameters A_sin and A_cos correspond to sin(θ/2) of Equation (10) and cos(θ/2) of Equation (11), respectively. In this embodiment, the phase compensation parameter A_sin is proportional to sin(θ/2), and the phase compensation parameter A_cos is proportional to cos(θ/2), where the proportional relationships mentioned above share the same proportional constant.

In a variation of this embodiment, the multiplier within the gain compensation module 112 is positioned on the I path, rather than being positioned on the Q path, where the multiplier is utilized for performing gain compensation on the I path according to the gain compensation parameter K_{I}, where the gain compensation parameter K_{I} can be derived by calculating 1/K_{Q}. In addition, the components to which the positive and negative input terminals of the arithmetic unit 124 are respectively coupled can be exchanged in this variation, where the positive and negative input terminals are respectively coupled to the square operation units 122-2 and 122-1. In this situation, the gain compensation parameter that is generated by utilizing the filter 128-1 to perform loop filtering on the difference calculated by the arithmetic unit 124 is K_{I}. Similar descriptions are not repeated for this variation.

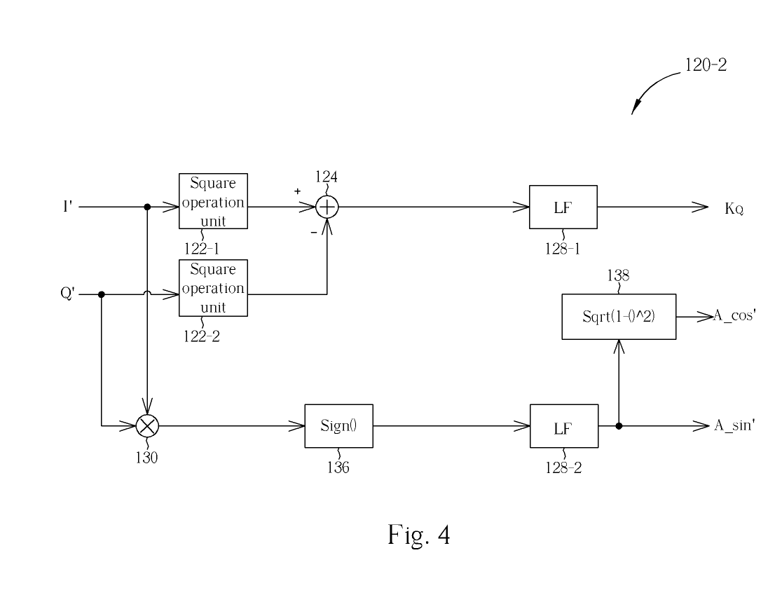

FIG. 4 is a diagram of a compensation parameter generation module 120-2 according to another embodiment of the present invention. In contrast to the compensation parameter generation module 120-1, a positive/negative sign detection unit 136 in the compensation parameter generation module 120-2 is utilized for replacing the arithmetic unit 126, the average operation units 132-1 and 132-2, and the division operation unit 134 mentioned above.

The positive/negative sign detection unit 136 detects a positive/negative sign of the product calculated by the multiplier 130 to generate a positive/negative sign detection result, and the filter 128-2 performs filtering on the positive/negative sign detection result to generate the phase compensation parameter A_sin′. Additionally, the calculation unit 138 generates the phase compensation parameter A_cos′ according to the phase compensation parameter A_sin′.

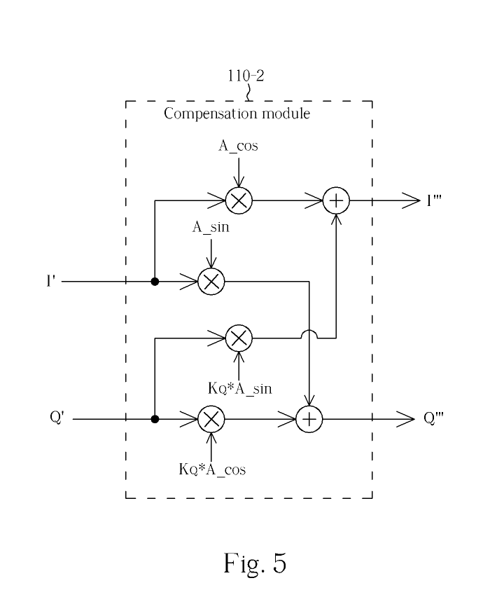

FIG. 5 is a diagram of a compensation module 110-2 according to another embodiment of the present invention, where this embodiment is a variation of the embodiment shown in FIG. 2, and the compensation module 110-2 can be utilized for replacing the compensation module 110-1 mentioned above. Thus, one multiplier can be omitted.

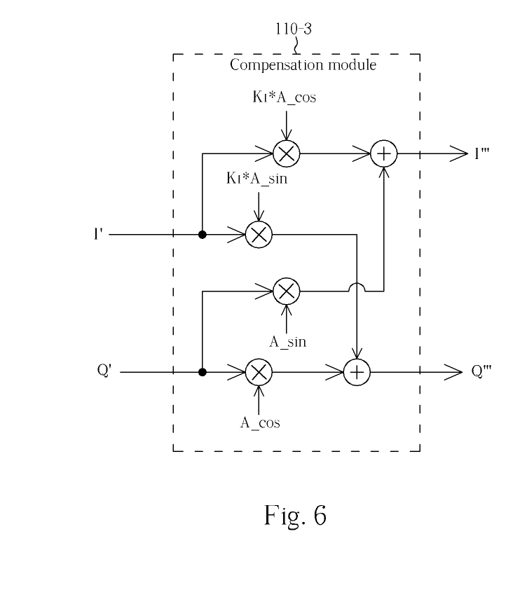

FIG. 6 is a diagram of a compensation module 110-3 according to another embodiment of the present invention, where this embodiment is also a variation of the embodiment shown in FIG. 2, and the compensation module 110-3 can be utilized for replacing the compensation module 110-1 or the compensation module 110-2 mentioned above. Similar descriptions are not repeated.

According to another embodiment of the present invention, the signal I′ and the signal Q′ inputted into the left of the closed loop architecture shown in FIG. 3 can be respectively replaced with the signal I′″ and the signal Q′″, where each of the filters 128-1 and 128-2 comprises an integrator or comprises a low pass filter including at least one pole according to different implementation choices of this embodiment. According to another embodiment of the present invention, the filters 128-1 and 128-2 can be omitted.

According to yet another embodiment of the present invention, the signal I′ and the signal Q′ inputted into the left of the closed loop architecture shown in FIG. 4 can be respectively replaced with the signal I′″ and the signal Q′″, where each of the filters 128-1 and 128-2 comprises an integrator or comprises a low pass filter including at least one pole according to different implementation choices of this embodiment.

According to other embodiments of the present invention, the gain compensation parameter K_{Q} and K_{I} can be derived by estimation performed by open loop architecture for implementing Equation (3) and Equation (4) respectively. In another embodiment, the phase compensation parameters A_sin and A_cos (and the corresponding sin(θ/2) and cos(θ/2)) can be derived by estimation performed by open loop architecture for implementing Equation (10) and Equation (11) respectively. In another embodiment, the phase compensation parameters A_sin and A_cos (and the corresponding sin(θ/2) and cos(θ/2)) can also be derived by operations performed on the signal I″ and the signal Q″.

While compensating IQ imbalance according to the embodiment(s) of the present invention, the errors on the I path and the Q path have been considered at the same time when deriving the equations mentioned above as the basis of the descriptions disclosed above, so the present invention indeed provides general solutions for compensating IQ imbalance in receivers. The present invention can be widely applied to various kinds of wireless communication systems, without any limitation of being merely applied to Orthogonal Frequency Division Multiplexing (OFDM) architecture. Therefore, regarding communication systems of non-OFDM architecture, the present invention is capable of conquering application bottlenecks of imbalance between different paths.

In addition, preferred embodiments of the present invention, such as the embodiments mentioned above, generate the phase compensation parameters A_sin and A_cos by estimating sin(θ/2) and cos(θ/2), where θ is utilized for representing the phase errors of the I path and the Q path, as shown in FIG. 1. This is a preferred choice of implementation, rather than a limitation of the present invention. According to other embodiments of the present invention, the relative angles of the I′-Q′ coordinate with respect to the I-Q coordinate can be replaced with other angles, to perform estimation of the phase compensation parameters A_sin and A_cos. For example, the angle between the Q′ axis and the Q axis can be replaced with (2θ/3) while the angle between the I′ axis and the I axis can be replaced with cos(θ/3), without hindering the implementation of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for compensating Inphase-Quadrature (IQ) imbalance in a receiver comprising:
generating a gain compensation parameter according to a first signal on an I path of the receiver and a second signal on a Q path of the receiver;
generating first and second phase compensation parameters according to the first signal and the second signal, wherein the first and the second phase compensation parameters substantially correspond to sin(θ/2) and cos(θ/2) respectively, and θ represents a phase error of the I path and the Q path; and
compensating the I path and the Q path of the receiver according to the gain compensation parameter, the first and the second phase compensation parameters.

2. The method of claim 1, wherein the step of generating the gain compensation parameter further comprises:
generating a first square value corresponding to the first signal on the I path, and a second square value corresponding to the second signal on the Q path;
calculating a difference between the first square value and the second square value; and
generating the gain compensation parameter according to the difference.

3. The method of claim 2, further comprising:
filtering the difference to generate the gain compensation parameter.

4. The method of claim 1, wherein the step of generating the first phase compensation parameter further comprises:
generating a first square value corresponding to the first signal, and a second square value corresponding to the second signal;
adding the first square value and the second square value to generate a sum;
averaging the sum to generate a first average value;
calculating a product of the first signal and the second signal;
averaging the product to generate a second average value; and
generating the first phase compensation parameter according to the first average value and the second average value.

5. The method of claim 4, wherein the first phase compensation parameter is generated according to a quotient derived from dividing the first average value by the second average value.

6. The method of claim 5, wherein the step of generating the gain compensation parameter further comprises:
calculating a difference between the first square value and the second square value; and
generating the gain compensation parameter according to the difference.

7. The method of claim 1, wherein the first phase compensation parameter is generated according to a positive/negative sign of a product of the first signal and the second signal.

8. The method of claim 1, wherein the second phase compensation parameter is generated according to the first phase compensation parameter.

9. The method of claim 1, wherein the step of compensating the I path and the Q path of the receiver further comprises:
compensating at least one of gains of the I path and the Q path according to the gain compensation parameter; and
compensating phases of the I path and the Q path according to the first and the second phase compensation parameters.

10. The method of claim 1, wherein the step of compensating the I path and the Q path of the receiver further comprises:
compensating the I path and the Q path according to a product of the gain compensation parameter and the first phase compensation parameter, a product of the gain compensation parameter and the second phase compensation parameter, the first phase compensation parameter, and the second phase compensation parameter.

11. The method of claim 1, wherein the first and the second compensation parameters are generated according to a correlation between the I path and the Q path.

12. The method of claim 1, wherein the receiver is applicable to a communication system, and the first and the second compensation parameters are independent of a carrier frequency offset of the communication system.

13. The method of claim 1, wherein the receiver is applicable to a communication system without any known signal.

14. A device for compensating Inphase-Quadrature (IQ) imbalance in a receiver comprising:
a compensation parameter generation module for generating first and second phase compensation parameters according to a first signal on an I path of the receiver and a second signal on a Q path of the receiver, wherein the first and the second phase compensation parameters substantially correspond to sin(θ/2) and cos(θ/2) respectively, and θ represents a phase error of the I path and the Q path; and
a compensation module, coupled to the compensation parameter generation module, for compensating the I path and the Q path according to the first and the second phase compensation parameters.

15. The device of claim 14, wherein the compensation parameter generation module generates a gain compensation parameter, and the compensation parameter generation module comprises:
a square operation unit for calculating the square value of the first signal and the square value of the second signal; and
a first arithmetic unit, for calculating the difference between the square value of the first signal and the square value of the second signal;
wherein the gain compensation parameter corresponds to the difference.

16. The device of claim 14, wherein the compensation parameter generation module comprises:
a multiplier for calculating a product of the first signal and the second signal;
wherein the first phase compensation parameter corresponds to a positive/negative sign of the product.

17. A method for compensating Inphase-Quadrature (IQ) imbalance in a receiver comprising:
generating a gain compensation parameter according to a first signal on an I path of the receiver and a second signal on a Q path of the receiver;
generating first and second phase compensation parameters according to a correlation between the first signal and the second signal; and
compensating the I path and the Q path according to the gain compensation parameter and the first and the second phase compensation parameters.

18. The method of claim 17, wherein the first and the second phase compensation parameters are generated by estimating sin(θ/2) and cos(θ/2), and θ represents a phase error of the I path and the Q path.

19. The method of claim 17, wherein the receiver is applicable to a communication system without any known signal.

20. The method of claim 17, wherein the receiver is applicable to a communication system, and the first and the second compensation parameters are independent of a carrier frequency offset of the communication system.
